(19) United States
(12) Patent Application Publication
(10) Pub. No.: US 2007/0160375 A1
(43) Pub. Date: Jul. 12, 2007

(54) Image forming apparatus

(75) Inventor: Nobuaki Fujisawa, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/650,989

(22) Filed: Jan. 9, 2007

(30) Foreign Application Priority Data
Jan. 10, 2006 (JP) 2006-002455

(51) Int. Cl. G03G 15/00; G03G 15/043; G03G 15/20

(52) U.S. Cl. 399/45; 399/51; 399/328

(57) ABSTRACT

An image forming apparatus (1) comprises a positioning mechanism (53) which displaces a first bearing (63) bearing a first end (62a) of a rotation shaft (62) of a backup roller (52) so that a rotation axis of the backup roller (52) takes a predetermined angle with respect to a rotation axis of a hot roller (51). When a thick envelope (E1) is printed, it is passed between the hot roller (51) and the backup roller (52) in a portion where a clearance between the hot roller (51) and the backup roller (52) is expanded in the vicinity of the first end (62a). When a thin envelope (E2) is printed, it is passed between the hot roller (51) and the backup roller (52) in a portion where a clearance between the hot roller (51) and the backup roller (52) is a little expanded in the vicinity of a second end (62b). Thereby, images can be formed properly on both of the thick envelope and the thin envelope without occurrence of corrugation or fixing failure of toner image on a surface of the envelope.

### BACKGROUND OF THE INVENTION

1. Field of the Invention

The present invention relates to an image forming apparatus of electrophotography system, and especially relates to a fuser/fixer of the image forming apparatus which presses and heats a recording paper sheet on which a toner image is formed while the recording paper sheet is interleaved between a hot roller and a backup roller facing the hot roller.

2. Description of the Related Art

Generally, in an image forming apparatus of electrophotography system such as a laser beam printer, a toner image formed on a recording paper is fixed by applying predetermined heat and pressure to the recording paper sheet with a fuser/fixer while the recording paper sheet is interleaved between a hot roller and a backup roller opposing each other. In such image forming apparatus, it is necessary to interleave the recording paper sheet between the hot roller and the backup roller with proper heat and pressure corresponding to a thickness of the recording paper sheet so as to form the image on the recording paper sheet with a proper image quality. If the pressure for interleaving the recording paper sheet is much smaller than a proper value, the heat is not conducted to the recording paper sheet enough, and thereby the toner is not fused and fixed on the recording paper sheet properly. Alternatively, if the pressure for interleaving the recording paper sheet is much large than the proper value, the recording paper sheet lengthens when the heat is applied to the recording paper sheet, and thereby corrugation occurs on the recording paper sheet. Therefore, it is necessary to adjust spacing between rotation axes of the hot roller and the backup roller to be a proper value corresponding to the thickness of the recording paper sheet.

In a conventional image forming apparatus of electrophotography system, the position of the rotation axis of the backup roller is displaced with a positioning mechanism using, such as an electric solenoid, so that the spacing between the rotation axes of the hot roller and the backup roller can be adjusted to two phases, and thereby, the image forming apparatus can respond to both of a thin plain paper and a thick envelope or a cardboard.

By the way, the envelopes have various thicknesses due to the thickness of the material paper thereof and the lamination of the envelope. Even when a thick envelope and a thin envelope are used as the recording paper sheet in the conventional image forming apparatus, since both of these envelopes are thicker than the plain paper, the spacing between the rotation axes of the hot roller and the backup roller is set to be wider in the above mentioned two phases. However, it is difficult to form the images on both of these thick and thin envelopes properly by the above mentioned conventional image forming apparatus. When the pressure applied to the envelope is adjusted to be proper to the thick envelope, the pressure becomes too weak to fuse and fix the toner image on the thin envelope properly. Alternatively, when the pressure applied to the envelope is adjusted to be proper to the thin envelope, the pressure becomes too strong so that the corrugation occurs on a surface of the thick envelope, as mentioned above.

Hereupon, Japanese Laid-Open Patent Publication No. 8-314304 discloses a conventional image forming apparatus that spacing between two rollers disposed in a passage of envelope is widened by a cam which rotates with the rollers so as to reduce a pressure by these two rollers for fixing the toner image on the envelope when the envelope is printed. However, the thin envelope is pressurized in a state where the spacing between the rollers is widened as well as the thick envelope is pressurized so that the above mentioned problems cannot be solved.

Japanese Laid-Open Patent Publication No. 8-160796 discloses a fuser/fixer which is constituted in a manner that a pressure for interleaving the recording paper sheet is set to be smaller and a heating quantity is set to be larger in a vicinity of a side serving as a guide to insert the envelope, and the pressure is set to be higher and the heat quantity is set to be smaller in a vicinity of the opposite side, so as to prevent the temperature rise in a portion where the recording paper sheet is not passed. However, since the envelope width of which is generally narrower than the recording paper sheet passes in the portion where the pressure is set to be smaller, the envelope is always pressurized weakly with no relation to the thickness of the envelope. Therefore, the above mentioned problems cannot be solved in this conventional fuser/fixer.

Japanese Laid-Open Patent Publication No. 10-274893 discloses a conventional image forming apparatus where bearing portions at both end of the rotation shaft of the backup roller are moved so as to warp the backup roller, and thereby, applying proper pressure to the recording paper sheet corresponding to the thickness of the recording paper sheet. However, the mechanism for warping the backup roller becomes complex and causes the cost rise.

### SUMMARY OF THE INVENTION

A purpose of the present invention is to provide an image forming apparatus of electrophotography system by which images can be formed properly on both of thick envelope and thin envelope without occurrence of corrugation or fixing failure of toner image on a surface of the envelope.

An image forming apparatus of electrophotography system in accordance with an aspect of the present invention comprises:

a photoconductor drum having a photoconductive layer on its surface;

a charging roller for electrically charging the surface of the photoconductor drum evenly;

an exposing device for forming a latent image on the surface on the photoconductor drum by irradiating laser beams while scanning in a main scanning direction;

a developer for developing the latent image by adhering toner particles on a portion of the surface of the photoconductor drum where the latent image is formed;

a transfer roller provided to face the surface of the photoconductor drum at a transferring position down stream from the developer in a rotation direction of the photoconductor drum for transferring the toner image formed on the surface of the photoconductor drum to a surface of a recording paper sheet;

a cleaner for removing remained toner particles on the surface of the photoconductor drum;

a fuser/fixer provided at a down stream position from the transferring position in a paper conveying direction and having a hot roller and a backup roller;

a paper feed tray on which a recording paper sheet is set;

a paper conveying mechanism for conveying the recording paper sheet toward the transferring position from the paper feed tray;

a first bearing and a second bearing respectively bearing a first end and a second end of a rotation shaft of the backup roller;

a positioning mechanism for displacing a position of the first bearing in a vertical direction so that a rotation axis of the backup roller takes a predetermined angle with respect to a rotation axis of the hot roller, and thereby, a clearance between surfaces of the hot roller and the backup roller is expanded in a vicinity of the first end of the rotation shaft of the backup roller; and

a controller for controlling at least the exposing device, the paper conveying mechanism, and the positioning mechanism with using an image data transmitted from an external device and information of a kind of the recording paper sheet.

According to such a configuration, when a thick envelope is to be printed, the clearance between the surfaces of the hot roller and the backup roller is expanded in the vicinity of the first end of the rotation shaft of the backup roller by activating the positioning mechanism. Thereby, the pressure applied to the thick envelope when it passes between the hot roller and the backup roller can be adjusted to be a proper value by passing the thick envelope in the portion where the clearance is expanded in the vicinity of the first end of the rotation shaft of the backup roller. Alternatively, when a thin envelope is to be printed, the clearance between the surfaces of the hot roller and the backup roller is a little expanded in the vicinity of the second end of the rotation shaft of the backup roller by activating the positioning mechanism. Thereby, the pressure applied to the thin envelope when it passes between the hot roller and the backup roller can be adjusted to be a proper value by passing the thin envelope in the portion where the clearance is a little expanded in the vicinity of the second end of the rotation shaft of the backup roller. Consequently, both of the thick envelope and the thin envelope can be printed properly with no occurrence of corrugation and no failure of fixing the toner image on the recording paper sheet.

On the other hand, an image forming apparatus of electrophotography system in accordance with another aspect of the present invention comprises:

an exposing means for forming a latent image on a surface of a photoconductor drum;

a developing means for developing the latent image on the surface of the photoconductor drum by adhering toner particles;

a transfer means for transferring developed toner image from the surface of the photoconductor drum to a surface of a recording paper sheet; and

a fixing means for fixing the toner image on the surface of the recording paper sheet, wherein

the fixing means has a hot roller for applying heat to the toner image and a backup roller for applying a pressure to the paper sheet while interleaving the recording paper sheet between the hot roller and the backup roller; and

a rotation axis of the backup roller can take a predetermined angle with respect to a rotation axis of the hot roller so as to expand a clearance between surfaces of the hot roller and the backup roller in a vicinity of an end of a rotation shaft of the backup roller, thereby enabling to apply proper heat and pressure to an envelope selected as the recording paper sheet corresponding to a thickness of the envelope.

According to such a configuration, both of the thick envelope and the thin envelope can be printed properly with no occurrence of corrugation and no failure of fixing the toner image on the recording paper sheet.

### BRIEF DESCRIPTION OF THE DRAWINGS

FIG. 1 is a sectional side view showing a configuration of an image forming apparatus in accordance with an embodiment of the present invention;

FIG. 2 is a perspective view showing a printing operation of the image forming apparatus for forming an image on a recording paper sheet of a plane paper;

FIG. 3A is a perspective view showing a printing operation of the image forming apparatus for forming an image on a recording paper sheet of a thick envelope; and

FIG. 3B is a perspective view showing a printing operation of the image forming apparatus for forming an image on a recording paper sheet of a thin envelope.

### DETAILED DESCRIPTION OF THE EMBODIMENT

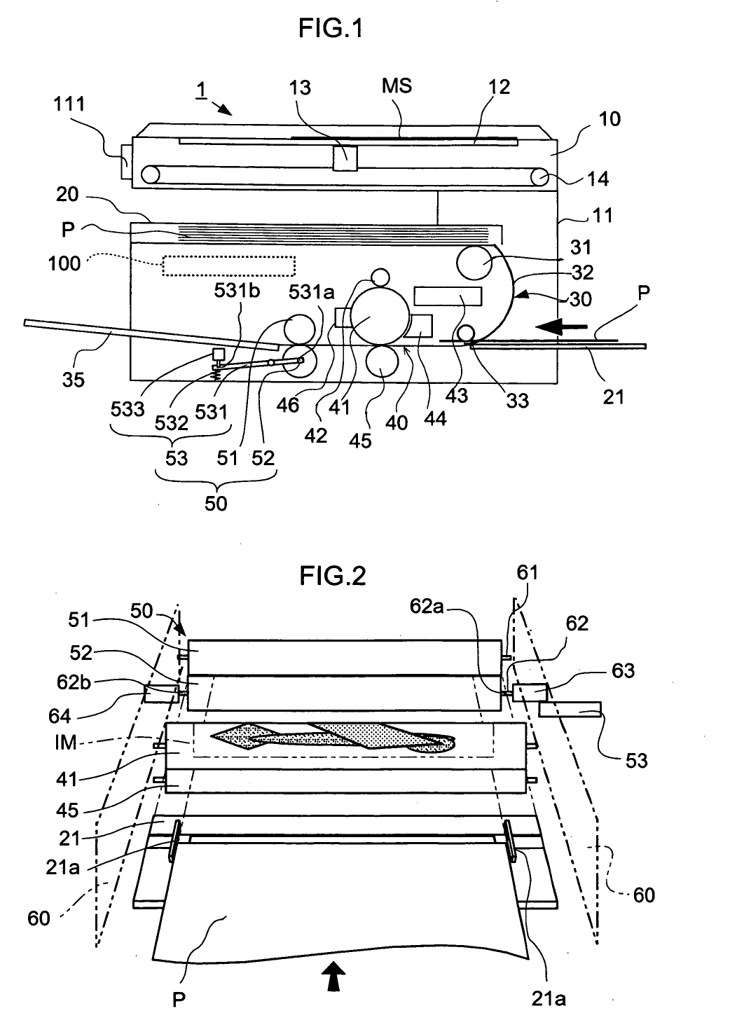

An image forming apparatus of electrophotography system in accordance with an embodiment of the present invention is described with reference to the figures. FIG. 1 shows a configuration of the image forming apparatus 1 of the embodiment. The image forming apparatus 1 is used to be connected with an external apparatus such as a personal computer. The image forming apparatus 1 has a printing function of a laser beam printer to form an image on a recording paper sheet of a size equal to or smaller than A4 or letter size by electrophotography system with using an image data transmitted from the external device such as a personal computer or a digital still camera, and a digital document copier. The image forming apparatus 1 is configured to enable the printing of an image on various kinds of recording paper sheet such as a plain paper or an envelope. Besides, the image forming apparatus 1 is not limited to such a multifunctional apparatus, and the image forming apparatus 1 may not have the digital document copier.

As shown in FIG. 1, a scanner 10 for reading a document MS as an image data is provided in an upper portion of the image forming apparatus 1. The scanner 10 is comprised of a document table 12 which is formed of a transparent material such as a glass and attached to a rectangular opening formed on an upper face of a housing 11, a scan unit 13 which is moved in a predetermined sub-scanning direction with facing an inner face of the document table 12, a driving mechanism 14 which drives the scan unit to move in the sub-scanning direction, and so on. The driving mechanism 14 is further comprised of a motor, pulleys and a belt so as to move the scan unit 13 along a guide rail provided parallel to the sub-scanning direction.

The scan unit 13 is called CIS (Contact Image Sensor), and comprised of a linear light source provided parallel to a main scanning direction perpendicular to the sub-scanning direction and an imaging device provided parallel to the linear light source, which are not illustrated. The linear light source is, for example, an array of LEDs (Light Emitting Diodes) arranged in the main scanning direction so as to illuminate a predetermined area of the document table 12 entirely and evenly in the main scanning direction. The imaging device is further comprised of a lens array in which minute lenses are arranged in the main scanning direction and an array of photo-sensing devices which are arranged in the main scanning direction corresponding to the lenses. Each lens is focused on an outer face of the document table 12, so that an image of a document in a predetermined area illuminated by the linear light source is focused on light receiving faces of the photo-sensing devices, and thereby, the image of the predetermined area is taken by the photo-sensing devices.

A paper feed cassette 20, which is one of paper feed trays on which recording paper sheets P are set, is provided just below the scanner 10. The paper feed cassette 20 is detachably mounted on the housing 11 of the image forming apparatus 1. A manual paper feed tray 21, which is another of the paper feed trays, is provided in a vicinity of the bottom of the housing 11. The manual paper feed tray 21 is generally used to form an image on a recording paper sheet which is different in size or king from that of the recording paper sheets P set in the paper feed cassette 20. Furthermore, an exit tray 35, to which printed recording paper sheets are exited, is provided in a portion opposite to the manual paper feed tray 21 in the housing 11. The recording paper sheet P set in the paper feed cassette 20 is conveyed to inside of the housing 11 by a paper sheet conveying mechanism 30 provided in the inside of the housing 11.

The paper sheet conveying mechanism 30 has a paper feeding roller 31 and a paper feeding guide 32 which are provided to face a front end portion of the bottom of the paper feed cassette 20, a paper conveying roller 33 to convey the recording paper sheet P which is conveyed along the paper feeding guide 32 or set on the manual paper feed tray 21 toward a transferring position which will be described later, and a motor, which is not illustrated, to drive the paper feeding roller 31 and the paper conveying roller 33.

An image forming unit 40 which forms an image on the recording paper sheet P by electrophotography system and a controller 100 which is comprised of, for example, an ASIC (Application Specific Integrated Circuit), a memory and so on and controls the operation of the image forming apparatus 1 are provided below the paper feed tray 20 in the inside of the housing 11. The image forming unit 40 is comprised of a photoconductor drum 41 which has a photoconductive layer on its surface, a charging roller 42 for electrically charging the surface of the photoconductor drum 41 evenly, an exposing device 43 for forming a latent image on the surface on the photoconductor drum 41 by irradiating laser beams while scanning in the main scanning direction, a developer 44 for developing the latent image by adhering toner particles on a portion of the surface of the photoconductor drum 41 where the latent image is formed, a transfer roller 45 provided to face the surface of the photoconductor drum 41 at the transferring position down stream from the developer 44 in the rotation direction of the photoconductor drum 41 for transferring the toner image formed on the surface of the photoconductor drum 41 to the surface of the recording paper sheet P, a cleaner 46 for removing remained toner particles on the surface of the photoconductor drum 41, and a fuser/fixer 50 provided at a down stream position from the transferring position in a paper conveying direction.

The exposing device 43 is comprised of a semiconductor laser outputting laser beams, a polygon mirror for reflecting the laser beams emitted from the semiconductor laser so as to scan in the main scanning direction, and an fθ lens for compensating aberration of the laser beams reflected by the polygon mirror corresponding to the reflection angle. The controller 100 controls emission and non-emission of the laser beam of the semiconductor laser with using the image data which is, for example read the document MS by the scanner 10, so that the surface of the photoconductor drum 41 is exposed by the laser beams, and thereby, the latent image is formed on the surface of the photoconductor drum 41.

The fuser/fixer 50 is comprised of a hot roller 51 which rotates about a rotation shaft 61 horizontally borne on a chassis 60 in the inside of the housing 11, a backup roller 52 which is rotatably borne on the chassis 60 below the hot roller 51 about a rotation shaft 62 parallel to the rotation shaft 61 of the hot roller 51, and a positioning mechanism 53 connected to a first bearing 63 which bears a first end 62a of the rotation shaft 62 of the backup roller 52 (hereinafter, abbreviated as “first end 62a of the backup roller 52”). The fuser/fixer 50 applies predetermined heat and pressure to a recording paper sheet P on which a toner image is transferred by interleaving the recording paper sheet P between the hot roller 51 and the backup roller 52, so that the toner image is fixed on the recording paper sheet P.

The first bearing 63, which bears the first end 62a of the backup roller 52, is movably held in a vertical direction by the positioning mechanism 53, and a second bearing 64, which bears a second end 62b of the rotation shaft 62 of the backup roller 52 (hereinafter, abbreviated as “second end 62b of the backup roller 52”), is movably held on the chassis 60 so as to swing the second end 62b of the backup roller 52 in a vertical plane. In other words, the second bearing 64 is held on the chassis 60 in a manner so that spacing between the rotation axes of the rotation shaft 61 of the hot roller 51 and the rotation shaft 62 of the backup roller 52 in the side of the second end 62b is substantially invariable.

The positioning mechanism 53 is comprised of a lever 531, a first lever end 531a of which is coupled with the first bearing 63, a spring 532 which is contacted to a second lever end 531b of the lever 531, and an electric solenoid 533 which is coupled with the second lever end 531b of the lever 531 and displaces the second lever end 531b by a predetermined distance. The lever 531 is pivoted on the chassis 60 at a position between the first lever end 531a and the second lever end 531b, so that the first lever end 531a of the lever 531 is displaced corresponding to the displacement of the second lever end 531b as a leverage. The spring 532 applies a force to displace the second lever end 531a of the lever 531 downward. The electric solenoid 533 pulls the second lever end 531a of the lever 531 upward against the force of the spring 532 when it is energized. The controller 100 controls the energization of the electric solenoid 533.

When the electric solenoid 533 is not energized, the first end 62a of the backup roller 52 is pressed toward the rotation shaft 61 of the hot roller 51 by the force of the spring 532. Under such a state, the rotation axis of the rotation shaft 62 of the backup roller 52 becomes parallel to that of the rotation shaft 61 of the hot roller 51.

When the electric solenoid 533 is energized, the second lever end 531b of the lever 531 is pulled upward, and thereby the first lever end 531a of the lever 531 is displaced downward so as to expand the spacing between the rotation axes of the rotation shaft 61 of the hot roller 51 and the rotation shaft 62 of the backup roller 52 in the side of the first end 62a. In other words, the rotation shaft 62 of the backup roller 52 is swung about the second end 62b in the vertical plane so that the rotation axes of the rotation shaft 61 of the hot roller 51 and the rotation shaft 62 of the backup roller 52 take a predetermined angle. At this time, a clearance is formed between the surface of the hot roller 51 and the surface of the backup roller 52 so that the clearance in the vicinity of the first end 62a of the backup roller 52 becomes wider than that in the vicinity of the second end 62b.

In the following description, the state, where the electric solenoid 533 is not energized, and thereby, the rotation axes of the rotation shaft 61 of the hot roller 51 and the rotation shaft 62 of the backup roller 52 are parallel to each other, is called “normal state”, and the state, where the electric solenoid 533 is energized, and thereby, the rotation axes of the rotation shaft 61 of the hot roller 51 and the rotation shaft 62 of the backup roller 52 take the predetermined angle, is called “envelope feeding state”.

The controller 100 controls the scanner 10 for reading a document MS disposed on the document table 12 as an image data, and controls the paper conveying mechanism 30 and the image forming unit 40 for forming an image on a recording paper sheet P. The controller 100 is configured to perform various operations corresponding to signals transmitted from the external personal computer or a control panel 111 provided on the housing 11 to be operated by a user.

In this embodiment, a kind of the recording paper sheet P is selectable, and the controller 100 controls the printing operation corresponding to the kind of the recording paper sheet P. The kind of the recording paper sheet P is selectable among a plain paper, a thin envelope, and a thick envelope, for example. The user selects the kind of the recording paper sheet P by operating keys of the control panel 111 or operating the external personal computer into which a printer driver is previously installed. Besides, the kind of the recording paper sheet P is not limited to the above mentioned examples.

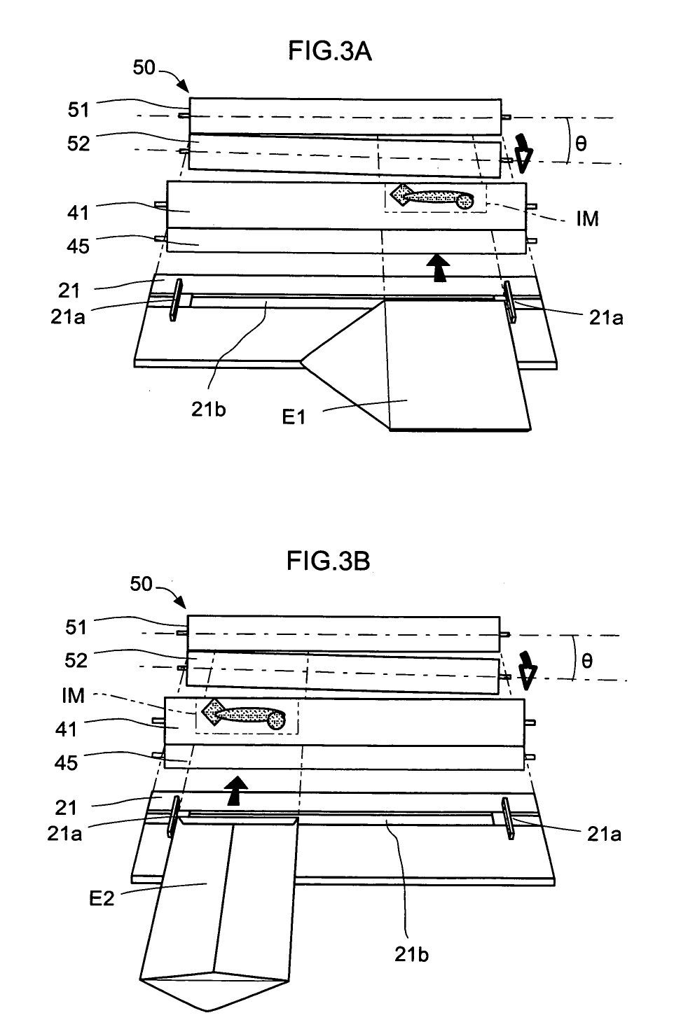

When the plain paper is selected as the kind of the recording paper sheet P, the controller 100 does not energize the electric solenoid 533, so that the printing operation is performed in the normal state of the fuser/fixer 50. Alternatively, when the thin envelope or the thick envelope is selected as the kind of the recording paper sheet P, the controller 100 energizes the electric solenoid 533, so that the printing operation is performed in the envelope feeding state of the fuser/fixer 50. Furthermore, when the thin envelope or the thick envelope is selected as the kind of the recording paper sheet P, the controller 100 controls the exposing device 43 of the image forming unit 40 to change the position of the toner image on the surface of the photoconductor drum 41 corresponding to the thin envelope or the thick envelope, as shown in FIGS. 3A and 3B.

Subsequently, a printing operation for forming an image on a recording paper sheet P which is, for example, a plain paper of A4 size or letter size and set in the manual paper feed tray 21 is described with reference to FIG. 2. When a thin plain paper is used as the recording paper sheet P, the user selects the plain paper as the kind of the recording paper sheet P so as to input information of the kind of the recording paper sheet P into the controller 100. In this printing operation, the fuser/fixer 50 is in the normal state.

A pair of paper guides 21 a is provided to be slidable in a groove 21 on the manual paper feed tray 21 for positioning the recording paper sheet P on the manual paper feed tray 21. Both side of the recording paper sheet P in the main scanning direction are restricted by the paper guides 21a. When the printing operation starts, the recording paper sheet P is conveyed in the direction shown by arrow in the figure by the paper conveying roller 33 toward the inside of the housing 11. Simultaneously, a toner image IM is formed on the surface of the photoconductor drum 41 by the image forming unit 40. Hereupon, when the recording paper sheet P is a plain paper, the toner image IM is formed on the basis of the center of the image forming unit 40 in the main scanning direction. In other words, the toner image IM is formed so that the center of the toner image IM coincides with the center of the photoconductor drum 41, and the recording paper sheet P is fed so that the center of the recording paper sheet P coincides with the center of the photoconductor drum 41.

When the recording paper sheet P is conveyed to the transferring position, the recording paper sheet P is interleaved between the photoconductor drum 41 and the transfer roller 45 so that the toner image IM is transferred to the surface of the recording paper sheet P. After transferring the toner image IM to the recording paper sheet P, the recording paper sheet P is conveyed while being interleaved between the hot roller 51 and the backup roller 52 of the fuser/fixer 50 so that the toner particles of the toner image is melted and pressed to the recording paper sheet P. Consequently, the toner image IM is fixed on the recording paper sheet P. Then, the printed recording paper sheet P on which the toner image IM is fixed is exited on the exit tray 35. In addition, in this embodiment, the recording paper sheet P set in the paper feed cassette 20 is conveyed toward the inside of the housing 11 along the paper feeding guide 32 by the paper feeding roller 31, and the image is formed the recording paper sheet P by the same manner as mentioned above.

Subsequently, a printing operation for forming an image on a recording paper sheet P which is, for example, an envelope is described with reference to FIGS. 3A and 3B. In FIGS. 3A and 3B, the chassis 60, the first and second bearings 63 and 64 and the positioning mechanism 53 are not illustrated.

When a thick envelope E1 is selected as the recording paper sheet P, the thick envelope E1 is set on the manual paper feed tray 21 on the basis of the first end 62a side (right side) of the backup roller 52, as shown in FIG. 3A. When a thin envelope E2 is selected as the recording paper sheet P, the thin envelope E2 is set on the manual paper feed tray 21 on the basis of the second end 62b side (left side) of the backup roller 52, as shown in FIG. 3B.

Hereupon, the thin envelope or the thick envelope may be experientially judged by the user. Alternatively, it is preferable to provide a slot gauge used for judging the thin or thick of the envelope on the housing 11. When the envelope can be passed the slit gauge, it may be judged as the thin envelope. After judging the envelope thin or thick, the user selects the kind of the envelope and inputs the information of the kind of the recording paper sheet P into the controller 100 as mentioned above. When the thin envelope or the thick envelope is selected as the recording paper sheet P, the controller 100 energizes the electric solenoid 533 of the positioning mechanism 53 so that the fuser/fixer 50 becomes in the envelope feeding state. In the envelope feeding state, the backup roller 52 is swung in the vertical plane as shown by outline arrow in FIGS. 3A and 3b, so that the tolerance between the hot roller 51 and the backup roller 52 in the vicinity of the first end 62 side of the backup roller 52 (the right side) becomes wider, and the rotation axis of the rotation shaft 62 of the backup roller 52 takes a predetermined angle θ with respect to the rotation axis of the rotation shaft 61 of the hot roller 51.

Prior to set the thick envelope E1 or the thin envelope E2 on the manual paper feed tray 21, the paper guides 21a are positioned at both ends in the groove 21b formed on the manual paper feed tray 21 in the main scanning direction. The length of the groove 21b corresponds to the largest width of the recording paper sheet P which can be printed by this image forming apparatus 1. The thick envelope E1 is set on the manual paper feed tray 21 with being guided by the paper guide 21a disposed at the first end 62a side (right side), as shown in FIG. 3A. In other words, the thick envelope E1 is set on the manual paper feed tray 21 on the basis of a predetermined position in the first end 62a side of the backup roller 52. The thin envelope E2 is set on the manual paper feed tray 21 with being guided by the paper guide 21a disposed at the second end 62b side (left side), as shown in FIG. 3B. In other words, the thin envelope E2 is set on the manual paper feed tray 21 on the basis of a predetermined position in the second end 62b side of the backup roller 52.

When the thick envelope E1 or the thin envelope E2 is set on the manual paper feed tray 21 and the printing operation is started, the controller 100 controls the exposing device 43 to form the toner image IM at a position on the photoconductor drum 41 which is different to the position to form the image on the plain paper. When the thick envelope E1 is selected as the recording paper sheet P, the toner image IM is formed on the surface of the photoconductor drum 41 on the basis of a side line of the largest recording paper sheet in the first end 62a side of the backup roller 52 (right side), as shown in FIG. 3A. When the thin envelope E2 is selected as the recording paper sheet P, the toner image IM is formed on the surface of the photoconductor drum 41 on the basis of a side line of the largest recording paper sheet in the second end 62b side of the backup roller 52 (left side), as shown in FIG. 3B.

When the toner image IM is formed on the surface of the photoconductor drum 41, the toner image IM is transferred to the thick envelope E1 or the thin envelope E2 which passes the transferring position. Subsequently, the thick envelope E1 or the thin envelope E2 is conveyed to the fuser/fixer 50.

The thick envelope E1 is interleaved between the hot roller 51 and the backup roller 52 of the fuser/fixer 50 in the vicinity of the first end 62a of the backup roller 52, so that the toner image IM is fixed on the surface of the thick envelope E1. Since the clearance between the surfaces of the hot roller 51 and the backup roller 52 in the vicinity of the first end 62a of the backup roller 52 is wider, the thick envelope E1 is pressed with an appropriate pressure corresponding to the thickness of the envelope E1. Thus, heat of the hot roller 51 is effectively conducted to the thick envelope E1. Consequently, the toner image IM is properly fixed on the surface of the thick envelope E1 with appropriate pressure and heat. Furthermore, the pressure applied to the thick envelope E1 can be adjusted to be the appropriate value by expanding the clearance between the surfaces of the hot roller 51 and the backup roller 52, so that no corrugation occurs on the surface of the thick envelope E1 while it is interleaved between the hot roller 51 and the backup roller 52.

On the other hand, the thin envelope E2 is interleaved between the hot roller 51 and the backup roller 52 of the fuser/fixer 50 in the vicinity of the second end 62b of the backup roller 52, so that the toner image IM is fixed on the surface of the thin envelope E2. Since the clearance between the surfaces of the hot roller 51 and the backup roller 52 in the vicinity of the second end 62b of the backup roller 52 is a little wider than that in the case for printing the plain paper, the thin envelope E2 is pressed with an appropriate pressure corresponding to the thickness of the envelope E2. Thus, heat of the hot roller 51 is effectively conducted to the thin envelope E2. Consequently, the toner image IM is properly fixed on the surface of the thin envelope E2 with appropriate pressure and heat. Furthermore, the pressure applied to the thin envelope E2 can be adjusted to be the appropriate value by expanding the clearance between the surfaces of the hot roller 51 and the backup roller 52 a little in comparison with the case of printing the plain paper, it is possible to prevent that the toner image IM is not properly fixed on the surface of the thin envelope E2.

In addition, the controller 100 controls the exposing device 43 so as to change the area on the surface of the photoconductor drum 41 where the latent image is formed corresponding to the kind of the recording paper sheet P, automatically. Thus, the user can obtain properly printed envelopes with no relation to the thickness of the envelope only by selecting the kind of the recording paper sheet P and setting the envelope to be printed at a proper position on the manual paper feed tray 21 corresponding to the thickness of the envelope.

In addition, the present invention is not limited to the configuration of the above mentioned embodiment, and can be modified appropriately in the scope of the invention. The image forming apparatus 1 may have a monitor display device such as an LCD (Liquid Crystal Display) to display the position to which the recording paper sheet, specially the envelope is set corresponding to the selected kind of the recording paper sheet P. By such a configuration, it is possible to prevent that the user erroneously set the envelope at the incorrect position.

Furthermore, the envelopes may be set in the paper feed cassette 20. The thick envelopes are set in the paper feed cassette 20 in a portion corresponding to the first end 62a of the backup roller 52, and the thin envelopes are set in the paper feed cassette 20 in a portion corresponding to the second end 62b of the backup roller 52. By such a configuration, a plurality of envelopes can be printed continuously without setting operation of new envelope one by one on the manual paper feed tray 21.

Still furthermore, the positioning mechanism 53 is not limited to the configuration of the above mentioned embodiment. For example, the spring 531 and the electric solenoid 533 may directly move the first bearing 63 which bears the first end 62a of the rotation shaft 62 of the backup roller 52 without using the lever 531. Alternatively, the spring 532 may be omitted so that the electric solenoid 533 or another actuator directly moves the first bearing 63.

Still furthermore, the positioning mechanism 53 may be driven manually by operating a lever which constitutes the positioning mechanism 53 from outside of the housing 11 by the user. In such a case, since the controller 100 cannot obtain the information of the kind of the recording paper sheet P, the position of the images to be printed may be changed by operating, for example, the external personal computer.

This application is based on Japanese patent application 2006-002455 filed Jan. 10, 2006 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. An image forming apparatus of electrophotography system comprising:
a photoconductor drum having a photoconductive layer on its surface;
a charging roller for electrically charging the surface of the photoconductor drum evenly;
an exposing device for forming a latent image on the surface on the photoconductor drum by irradiating laser beams while scanning in a main scanning direction;
a developer for developing the latent image by adhering toner particles on a portion of the surface of the photoconductor drum where the latent image is formed;
a transfer roller provided to face the surface of the photoconductor drum at a transferring position down stream from the developer in a rotation direction of the photoconductor drum for transferring the toner image formed on the surface of the photoconductor drum to a surface of a recording paper sheet;
a cleaner for removing remained toner particles on the surface of the photoconductor drum;
a fuser/fixer provided at a down stream position from the transferring position in a paper conveying direction and having a hot roller and a backup roller;
a paper feed tray on which a recording paper sheet is set;
a paper conveying mechanism for conveying the recording paper sheet toward the transferring position from the paper feed tray;
a first bearing and a second bearing respectively bearing a first end and a second end of a rotation shaft of the backup roller;
a positioning mechanism for displacing a position of the first bearing in a vertical direction so that a rotation axis of the backup roller takes a predetermined angle with respect to a rotation axis of the hot roller, and thereby, a clearance between surfaces of the hot roller and the backup roller is expanded in a vicinity of the first end of the rotation shaft of the backup roller; and
a controller for controlling at least the exposing device, the paper conveying mechanism, and the positioning mechanism with using an image data transmitted from an external device and information of a kind of the recording paper sheet.

2. The image forming apparatus in accordance with claim 1 further comprising:
a control panel with keys used to select the kind of the recording paper sheet among at least a plain paper, a thin envelope and a thick envelope.

3. The image forming apparatus in accordance with claim 1, wherein
the controller controls the exposing device to change an area on the surface of the photoconductor drum where the toner image is formed corresponding to the kind of the recording paper sheet.

4. The image forming apparatus in accordance with claim 3, wherein
the kind of the recording paper sheet is selectable among at least a plain paper, a thin envelope and a thick envelope;
when the plain paper is selected as the recording paper sheet, the controller does not control the displacing mechanism so as not to expand the clearance between the surfaces of the hot roller and the backup roller in the vicinity of the first end of the rotation shaft of the backup roller, and controls the exposing device so as to form the toner image on a basis of a center of the photoconductor drum in the main scanning direction;
when the thick envelope is selected as the recording paper sheet, the controller controls the displacing mechanism so as to expand the clearance between the surfaces of the hot roller and the backup roller in the vicinity of the first end of the rotation shaft of the backup roller, and controls the exposing device so as to form the toner image on a basis of a side line of a largest recording paper sheet which can be printed in the image forming apparatus in the first end side of the backup roller; and
when the thin envelope is selected as the recording paper sheet, the controller controls the displacing mechanism so as to expand the clearance between the surfaces of the hot roller and the backup roller in the vicinity of the first end of the rotation shaft of the backup roller, and controls the exposing device so as to form the toner image on a basis of a side line of the largest recording paper sheet in the second end side of the backup roller.

5. The image forming apparatus in accordance with claim 4 further comprising:
a monitor display device to display a position on the paper feed tray to which the recording paper sheet is set corresponding to the selected kind of the recording paper sheet.

6. The image forming apparatus in accordance with claim 1, wherein
the positioning mechanism comprises at least a spring which applies a force to the first bearing so as to maintain the rotation axis of the backup roller parallel to the rotation axis of the hot roller, and an actuator which moves the first bearing against the force of the spring when it is energized by the controller.

7. The image forming apparatus in accordance with claim 1, wherein
the paper feed tray is a manual paper feed tray; and
a pair of paper guides is provided to be slidable in a groove on the manual paper feed tray for positioning the recording paper sheet on the manual paper feed tray.

8. The image forming apparatus in accordance with claim 1, wherein
the second bearing is movably held on a chassis so as to swing the second end of the rotation shaft of the backup roller in a vertical plane.

9. An image forming apparatus of electrophotography system comprising:
an exposing means for forming a latent image on a surface of a photoconductor drum;
a developing means for developing the latent image on the surface of the photoconductor drum by adhering toner particles;
a transfer means for transferring developed toner image from the surface of the photoconductor drum to a surface of a recording paper sheet; and
a fixing means for fixing the toner image on the surface of the recording paper sheet, wherein
the fixing means has a hot roller for applying heat to the toner image and a backup roller for applying a pressure to the paper sheet while interleaving the recording paper sheet between the hot roller and the backup roller; and
a rotation axis of the backup roller can take a predetermined angle with respect to a rotation axis of the hot roller so as to expand a clearance between surfaces of the hot roller and the backup roller in a vicinity of an end of a rotation shaft of the backup roller, thereby enabling to apply proper heat and pressure to an envelope selected as the recording paper sheet corresponding to a thickness of the envelope.
